(19) United States
(12) Patent Application Publication
(10) Pub. No.: US 2014/0087073 A1
(43) Pub. Date: Mar. 27, 2014

(54) EQUIPMENT AND METHOD OF MANUFACTURING FOR LIQUID PROCESSING IN A CONTROLLED ATMOSPHERIC AMBIENT

(71) Applicants: Igor Constantin Ivanov, Danville, CA (US); Robin Cheung, Cupertino, CA (US)

(72) Inventors: Igor Constantin Ivanov, Danville, CA (US); Robin Cheung, Cupertino, CA (US)

(21) Appl. No.: 14/035,567

(22) Filed: Sep. 24, 2013

Related U.S. Application Data
(60) Provisional application No. 61/704,862, filed on Sep. 24, 2012.
(60) Provisional application No. 61/831,026, filed on Jun. 4, 2013.

(51) Int. Cl. B05C 9/06; B05D 1/38

(52) U.S. Cl. CPC B05C 9/06; B05D 1/38
USPC 427/248.1; 118/719

(57) ABSTRACT

In various exemplary embodiments, a system and related method for processing substrates is provided. In one embodiment, a substrate processing system is provided that includes a substrate load module, a plurality of facilities modules, a plurality of process chambers, a substrate transfer module, at least one transfer gate to provide a contamination barrier between various ones of adjacent modules, and at least one gas impermeable shell to provide a controlled atmosphere within the substrate processing system.

### PRIORITY APPLICATION

This application claims the benefit of priority under 35 U.S.C. 119(e) to U.S. Provisional Patent Application Ser. Nos. 61/704,862 and 61/831,026, each entitled “EQUIPMENT AND METHOD OF MANUFACTURING FOR LIQUID PROCESSING IN A CONTROLLED ATMOSPHERICE AMBIENT,” filed on Sep. 24, 2012 and Jun. 4, 2013, respectively, which are hereby incorporated by reference herein in their entireties.

### TECHNICAL FIELD

The present application relates generally to the field of fabrication of electronic components and, in a specific embodiment, to a system and method of manufacturing electronic and optical devices.

### BACKGROUND

An electronic device manufacturing process consists of many steps where some materials are not only sensitive to the environment during deposition or etch processes but the formed films are protected to prevent damage during transfer to another process module. A conventional approach is to deposit sensitive material first and then quickly transfer to another tool to deposit a protective layer. However, modern high performance materials frequently cannot sustain even a short exposure to air during transfer from a process chamber to, for example, a substrate storage cassette.

A significant number of manufacturing processes employ hazardous or harmful chemicals which can have a negative impact on both the health of individuals involved in manufacturing process and on stability of other manufacturing steps within a factory environment. The chemicals may be isolated from the environment.

Therefore, there is a need for a manufacturing apparatus which can process a substrate which can meet performance and reliability requirements, reduce damage to sensitive materials, and prevent at least some health hazards associated with a typical electronic device manufacturing process.

### BRIEF DESCRIPTION OF DRAWINGS

Various ones of the appended drawings merely illustrate various embodiments and examples of the subject matter presented herein. Therefore, the appended drawings are provided to allow a person of ordinaty skill in the art to better understand the concepts disclosed herein, and therefore cannot be considered as limiting a scope of the disclosed subject matter.

FIG. 1 shows an example of a system to extract waste from a controlled or sealed environment with reduced air backflow into the controlled environment;

FIG. 2 shows an embodiment of a method of extracting waste from a controlled or sealed environment without air backflow into the controlled environment;

FIG. 3 shows an example of a processing system layout with process chambers;

FIG. 4 shows another an example of a configuration of a processing system;

FIG. 5 shows an example of a process tool;

FIG. 6 shows an example of a processing system; and

FIG. 7 shows an example of a process flow-through environment controlled processing system where a final encapsulated substrate can be exposed to air and transferred to other processing systems.

### DETAILED DESCRIPTION

The description that follows includes illustrative systems, methods, techniques, and sequences, that embody various aspects of the subject matter described herein. In the following description, for purposes of explanation, numerous specific details are set forth to provide an understanding of various embodiments of the subject matter. It will be evident, however, to those skilled in the ad, that embodiments of the subject matter may be practiced without these specific details. Further, well-known methods, protocols, structures, and techniques have not been shown in detail.

As used herein, the term “or” may be construed in either an inclusive or exclusive sense. Similarly, the term “exemplary” is construed merely to mean an example of something, or an exemplar, and not necessarily a preferred or ideal means of accomplishing a goal. Additionally, although various embodiments discussed below focus on particular processing techniques, systems, and methods, the embodiments are given merely for clarity in disclosure. Thus, various types of processing techniques, systems, and methods are considered as being within a scope of the subject matter described.

### Controlled Ambient Process Tool and Components.

In the manufacturing of electronic and optical devices, such as image sensors, solar cells, displays, and other products, fabrication using materials and chemicals dispersed in the solution phase offers advantages in cost, scale, and the potential for materials self-organization.

The atmosphere under which processing is carried out can play a role in the properties of the end product. As one example, certain reagents and particles may be prone to oxidation. For this reason, manufacturing in a controlled environment potentially one having an atmosphere that excludes oxygen and humidity, such as, for example, a dry nitrogen or argon environment—may be desirable.

In processing materials from the solution phase, inevitably some poi on of material may not be adsorbed onto the final substrate, but instead becomes a waste product of the manufacturing process. This can be true of solvents used to introduce materials or chemicals onto a substrate. In certain cases, the solvents are not to be incorporated into the final product, but instead serve as delivery vehicles for chemicals solvated in, or particles dispersed in, the solvent. It may also be true of some portion of the materials that are intended to make up the final product, for some fraction of materials introduced in the solution phase may not reach, or be finally incorporated onto, the final substrate or product.

Therefore, in a manufacturing flow, it may be desirable to offer a means of removing waste solvents an for materials, and to do so in a manner that preserves a desired processing environment.

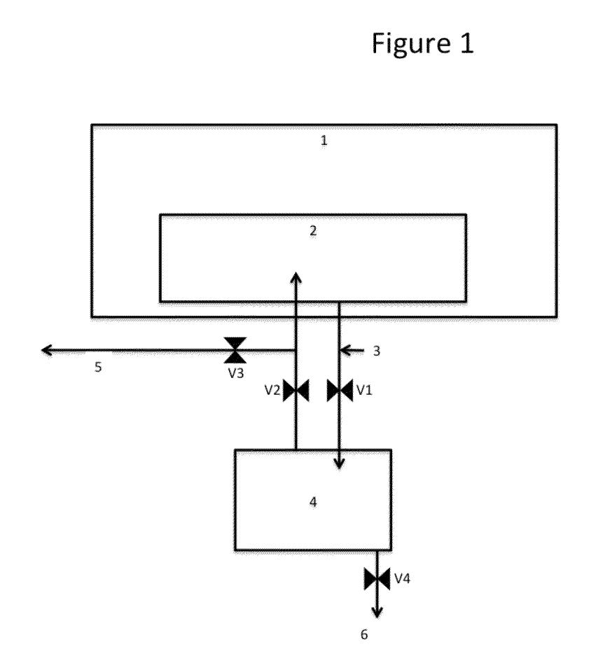

FIG. 1 shows an example of a system to extract waste from a controlled or sealed environment with reduced air backflow into the controlled environment; thereby permitting preservation of a desired process environment within a liquid process chamber.

Referring to FIG. 1, region (1) refers to a controlled environment containing region (2), a liquid process chamber. Element number (3) is a liquid process drain that allows waste resultant from processing in region (2) to be conveyed to a sealed waste container (4). The sealed waste container (4) may, in embodiments, provide the same controlled environment as that in regions (1) and (2).

V1 is a valve that regulates the flow of gas and material from the liquid process chamber (2) to the sealed waste container (4). V2 is a valve that regulates the backflow of gas and material from the sealed waste container; and also to an exhaust line (5). V3 is a valve that regulates the flow of gas and material from the lines, controlled by V2 and V1, that connects the sealed waste container and the liquid process chamber, and that is also connected to exhaust line (5). V4 is a valve that connects the sealed waste container (5) to a drain (6) for removal of the waste material.

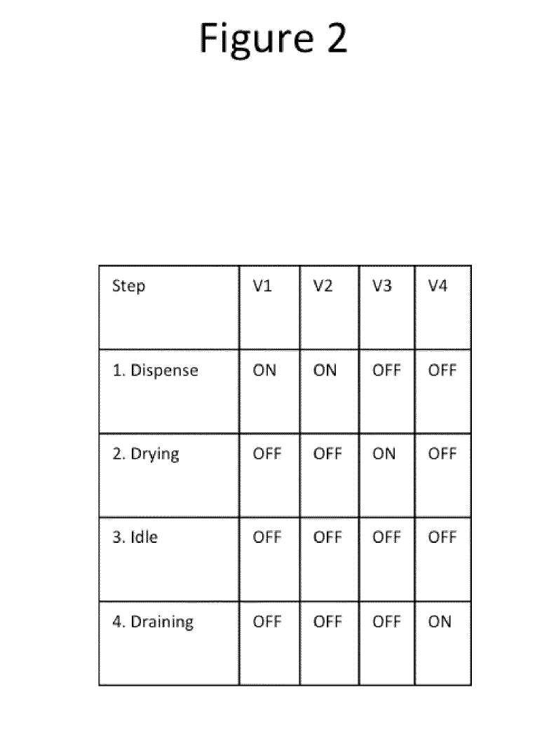

With continuing reference to FIG. 1, FIG. 2 depicts an embodiment of a method of extracting waste from a controlled or sealed environment without air backflow into the controlled environment; thereby permitting preservation of a desired process environment within the liquid process chamber.

In a first interval (1), known as the Dispense interval a liquid, potentially containing a material, is dispensed onto a substrate. In a second interval (2), known as the Drying interval, the liquid is allowed to at least partially evaporate to result in a partially or completely dry substrate. In a third interval (3), known as the idle interval, the lines are permitted to return to an ambient determined by the environment in the liquid process chamber and the waste chamber. In a fourth interval (4), known as the Draining interval, waste is removed from the sealed waste container and is communicated to the drain.

In embodiments, during interval (1) Dispense, liquid is dispensed onto the substrate in the liquid process chamber. V1 is open to permit excess liquid to be conveyed from the liquid process chamber to the sealed waste container. V2 is open to permit pressures to remain normalized during this process, to permit the flow of liquid from the liquid process chamber into the sealed waste container. V3 is closed to prevent or reduce undesired backflow of ambient air through the exhaust line. V4 is closed to prevent or reduce undesired backflow of ambient air from the drain.

In embodiments, during interval (2) Drying, the material deposited onto the substrate is permitted to dry (e.g., for its solvent to evaporate). V1 and V2 may be closed since no liquid material is being communicated to the sealed waste container during this interval, it having been so communicated during interval (1). V3 is open to permit the egress of solvent-rich vapor from the liquid process chamber to the exhaust. V4 may be closed to preserve the environment within the liquid process chamber.

In embodiments, during interval (3) Idle, all valves are closed. This interval gives a period of time during which all relevant lines, and all relevant chambers, can return to the desired process environment such as provided by sources of certain ambient gases, such as N₂, Argon, etc.

In embodiments, during interval (4) Draining, V1 and V2 and V3 are off since no liquid waste is being transferred from the liquid process chamber to the sealed waste container; and V4 is open in order to communicate waste from the sealed waste container to the drain. By closing V1, V2, and V3 during this interval, the desired ambient is preserved in liquid process chamber at all times.

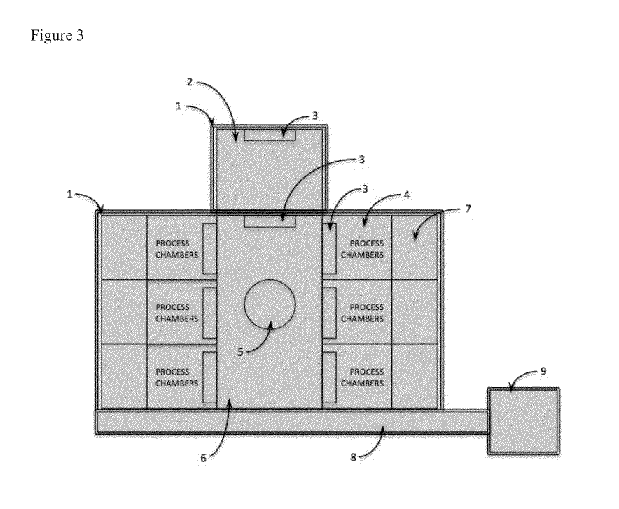

FIG. 3 shows an example of a processing system layout where all process chambers (4), substrate loading (2) and substrate transfer (6) modules, and facilities (e.g., electronics, pneumatics, and liquid handling) modules (7), including substrate transfer mechanism (5) may be enclosed in a gas-impermeable shell (1). The gas impermeable shell may be made of stainless steel, aluminum, plastic, or other similar materials. Each of the process chambers (4) and loading (2) modules can be isolated by agate (3) (e.g., a transfer gate) to prevent chemical vapor cross-contamination between modules.

Consumable materials, such as gases and liquids, are delivered to the system via conventional pressurized supply lines isolated from the processing system using isolation valves. The exhaust system (8) handles process vapors which may be neutralized or filtered in a hazardous material treatment module (9).

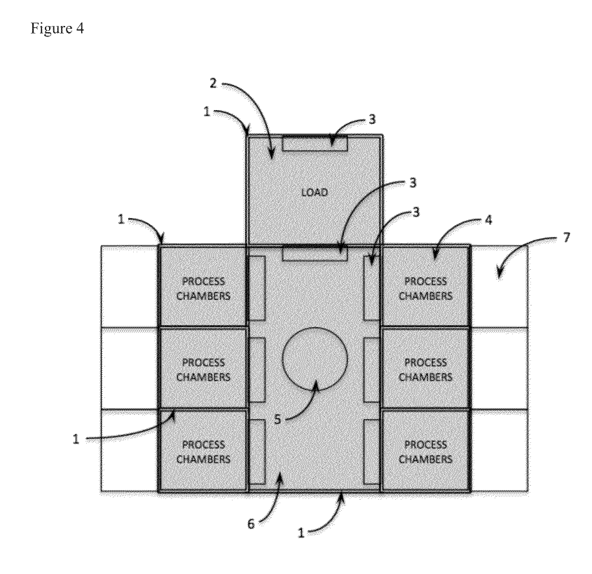

FIG. 4 shows another an example of a configuration of a processing system where each module (2), (4), (6) has its own isolation shell (1) and each process chamber is isolated from an adjacent module or ambient using agate (3). Auxiliary modules (7) in the system are located outside the sealed enclosure and allow easy maintenance and service.

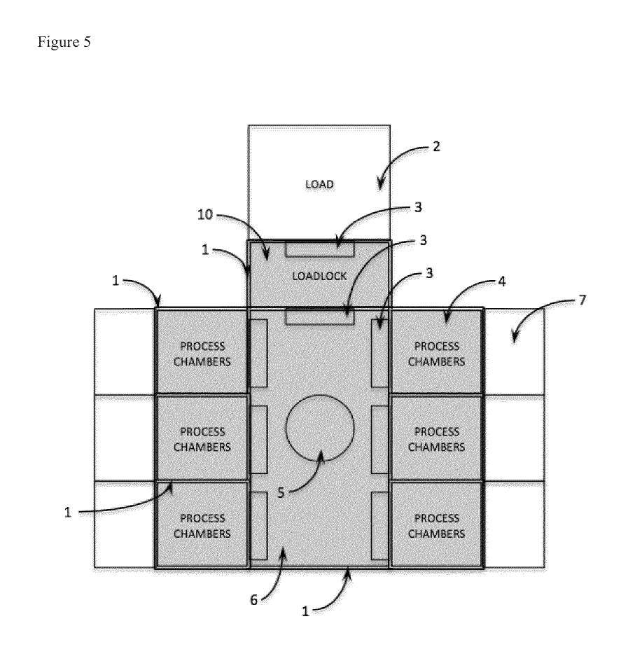

FIG. 5 shows an example of a process tool where a loading module (is a conventional substrate cassette module, such as, for example, a Front Opening Universal Pod (FOUP), a Standard Mechanical Inter Face (SMIF) pod, or an open cassette. As all environment sensitive processes may be carried out inside sealed (1) modules, the loading module is separated from process environment by using sealed loadlock chamber (10).

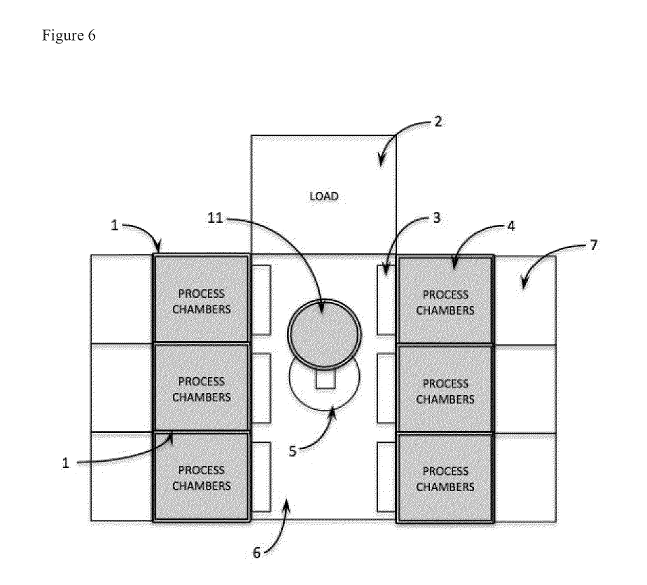

FIG. 6 shows an example of a processing system consisting of a conventional loading module (2), isolated process modules (4), conventional substrate transfer module (6), and conventional substrate transfer mechanism (5). In order to prevent substrate exposure to air during transfer from one process chamber to another process chamber, a substrate may be protected from air by a mechanism (11) which provides continuous flow of neutral gas such as nitrogen over the substrate surface. Such configuration allows utilization of less expensive conventional modules thus reducing total cost of ownership of the processing system.

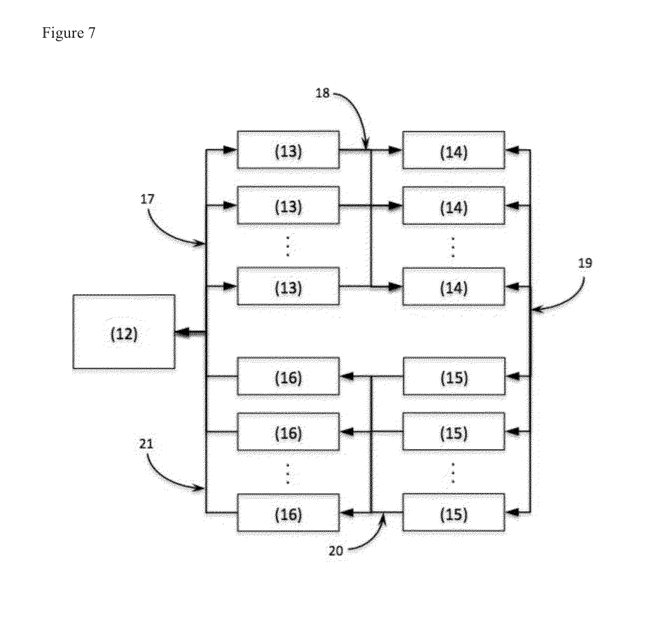

FIG. 7 shows an example of a process flow-through environment controlled processing system where a final encapsulated substrate can be exposed to air and transferred to one or more other processing systems.

Step one of an example of a process flow is a substrate transfer from a substrate cassette (12) holding multiple substrates which are moved into one of the first types of process chambers (13) through a gate (not described here) by a substrate transfer mechanism motion (17).

Step two of the process is substrate treatment in one of the chambers (13) to clean the substrate, to etch, to degas, or to activate the surface.

Step three of the process is substrate transfer (18) to one of the process chambers (14).

Step four of the process is deposition of a film in chambers (14).

Step five is substrate transfer (19) to one of the process chambers (15).

Step six is a substrate treatment in process chambers (15).

Step seven is substrate transfer (19) to process chambers (14). Steps six and seven can be repeated multiple times for the purpose of deposition of thick films or stack of films with different compositions.

Step eight is substrate transfer (20) to one of the process chambers (16).

Step nine is a substrate treatment in process chambers (16) for the purpose of creating a final protective layer.

Step ten is a substrate transfer (21) to a substrate cassette (12).

Various examples and embodiments have been provided herein. In one example, system for liquid processing is provided. The system comprises a liquid processing chamber; a first valve-controlled line; a sealed waste container; and a second valve-controlled line, the liquid processing chamber being coupled to the sealed waste container using the first valve-controlled line, the sealed waste container being coupled to a drain using the second valve-controlled line.

In another example, a method of liquid processing is provided. The method comprises during a first interval, liquid is dispensed onto a substrate, and excess liquid and material travel to a sealed waste container; during a second interval, drying the liquid; during a third interval, the process environment in lines and chambers is permitted to return to ambient; and during a fourth interval, draining waste liquid from the sealed waste container to a drain, during the first interval, liquids and gases are permitted to flow between the liquid process chamber and the sealed waste container, during the second, third, and fourth intervals, liquids and gases are substantially prevented from flowing between the liquid process chamber and the sealed waste container.

In another example, a substrate processing system is provided. Ther substrate processing system comprises multiple process chambers, substrate handling environment and components, and substrate loading stations where all components of the system operate in controlled atmosphere.

In another example, a substrate processing system where all components are enclosed in one enclosure.

In another example, a substrate processing system is provided where each component is isolated from the environment but prevents or reduces substrate exposure to the environment during substrate handling.

In another example, a substrate processing system is provided that is configured to deliver substrates with an anticorrosion protective coating.

In various embodiments, the substrates may be comprised of one or more substrates that are semiconductor wafers, solar panels, LED, LCD, OLED panels, and other substrates where films are deposited.

In various embodiments, the multiple process chambers are liquid, thermal, and/or vapor phase chambers. The liquid process chambers can be employing spin-on, spin-cast, drop-cast, spray, or ink-jet technologies. Thermal process chambers are capable of programmable thermal processing (e.g., temperature, pressure, gas) of substrates in vacuum, atmospheric pressure, or pressures above atmospheric. Vapor phase chambers may employ vapor phase condensation, chemical vapor deposition, atomic layer deposition, molecular layer deposition, pulsed laser deposition, and/or physical vapor deposition technologies. Both thermal and vapor phase chambers may provide a capability of changing substrate temperature in-situ.

In various embodiments, all components may be isolated from the ambient and provide capability to fill components with non-corrosive gas or chemical vapor.

In one example, a vacuum chamber with a heated (and/or cooled) substrate holder for vapor phase deposition of thin films is provided where the substrate is placed into the chamber at low (e.g., room) temperature in a controlled environment and consequently film is deposited when the substrate reaches a predetermined temperature.

In one example, a vacuum chamber is provided where more than one chemical precursor is a vapor form that can be delivered into a chamber either sequentially, at the same time, or in a mixed mode.

In one example, a vacuum chamber is provided where a substrate is placed on a heated substrate holder after reaching predetermined environment conditions (e.g., vacuum, pressure, gas flow) inside a sealed chamber.

In one example, a vacuum chamber is provided where a substrate is removed from a heated substrate holder before reaching predetermined environment conditions (e.g., vacuum, pressure, gas flow) inside sealed chamber prior to removing substrate from a vacuum chamber.

In one example, a method of a thin film encapsulation is provided utilizing a sequence of liquid processes to form the film, one or more thermal processes to stabilize the film, and one or more vapor phase deposition process to prevent or reduce the film from exposure to corrosive environment by executing all processes within sealed environment filled with non-corrosive or reducing gas or mixture of gases.

The embodiments illustrated herein are described in sufficient detail to enable those skilled in the art to practice the teachings disclosed. Other embodiments may be used and derived therefrom, such that structural and logical substitutions and changes may be made without departing front the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, and other components may be somewhat arbitrary, and particular operations are illustrated in a context of specific illustrative configurations. Other allocations of functionality are envisioned and may fall within a scope of various embodiments of the present invention. In general, structures and functionality presented as separate resources in the exemplary configurations may be implemented as a combined structure, resource, or component. Similarly, structures and functionality presented as a single resource may be implemented as separate resources.

These and other variations, modifications, additions, and improvements fall within a scope of the inventive subject matter as represented by the appended claims. The specification and drawings are, accordingly, to be regarded in an illustrative rather than a restrictive sense.

What is claimed is:

1. A substrate processing system, comprising:
a substrate load module;
a plurality of facilities modules;
a plurality of process chambers;
a substrate transfer module;
at least one transfer gate to provide a contamination barrier between various ones of adjacent modules; and
at least one gas impermeable shell to provide a controlled atmosphere within the substrate processing system.

2. The substrate processing system of claim 1, wherein the substrate load module, the plurality of facilities modules, the plurality of process chambers, and the substrate transfer module are enclosed within the at least one gas impermeable shell.

3. The substrate processing system of claim 1, wherein only the substrate load module, the plurality of process chambers, and the substrate transfer module are enclosed within the at least one gas impermeable shell.

4. The substrate processing system of claim 1, further comprising a loadlock chamber that is separately enclosed within a separate one of the at least one gas impermeable shell.

5. The substrate processing system of claim 1, further comprising a continuous flow mechanism within the substrate transfer module, the continuous flow mechanism to flow a neutral gas over a substrate when the substrate is within the substrate transfer module.

6. The substrate processing system of claim 1, wherein the substrate processing system is configured to process at least one of type of substrates from a group of substrate types comprising semiconductor wafers, solar panels, LED panels, LCD panels, OLED panels, and other substrates onto which films are to be deposited.

7. The substrate processing system of claim 1, wherein the plurality of process chambers include at least one of a liquid process chamber, a thermal process chamber, and a vapor phase chamber.

8. The substrate processing system of claim 7, wherein the liquid process chamber is configured to deposit liquids onto a substrate as a spin-on, a spin-cast, a drop-cast, a spray, or an ink-jet technology.

9. The substrate processing system of claim 7, wherein the thermal process chamber is configured to provide programmable thermal processing, programmable thermal processing to include programming of at least one variable of process temperature, process pressure, and process gas distribution with the thermal process chamber.

10. The substrate processing system of claim 7, wherein the vapor phase chamber is configured to provide at least one type of deposition selected from deposition types including vapor phase condensation, chemical vapor deposition, atomic layer deposition, molecular layer deposition, pulsed laser deposition, and physical vapor deposition technologies.

11. The substrate processing system of claim 7, wherein the thermal process chamber and the vapor phase chamber are configured to change a temperature of the substrate in-situ.

12. The substrate processing system of claim 1, wherein at least one of the plurality of process chambers is selectably configured to process the substrates in vacuum, at atmospheric pressure, and at pressures above atmospheric pressure.

13. The substrate processing system of claim 1, wherein the substrate load module, the plurality of facilities modules, the plurality of process chambers, and the substrate transfer module are isolated from an ambient environment.

14. The substrate processing system of claim 1, wherein at least one of the substrate load module, the plurality of process chambers, and the substrate transfer module are configured to be filled with a non-corrosive gas or a chemical vapor.

15. The substrate processing system of claim 1, further comprising a vacuum chamber having a substrate holder configured to heat and cool a substrate, the vacuum chamber further to provide a vapor phase deposition of thin films onto the substrate, wherein the substrate is to be placed into the vacuum chamber at a substantially ambient room temperature in a controlled environment and a film is to be deposited onto the substrate after the substrate reaches a predetermined temperature.

16. The substrate processing system of claim 15, wherein the vacuum chamber is configured to provide a plurality of chemical precursor vapors to the substrate, the vacuum chamber being further configured to provide the plurality of chemical precursor vapors to the substrate sequentially, concurrently, or alternatively in a mixed mode.

17. The substrate processing system of claim 15, wherein the substrate processing system is configured to place the substrate onto a heated substrate holder within the vacuum chamber after the vacuum chamber has reached predetermined environmental conditions.

18. The substrate processing system of claim 17, wherein the predetermined environmental conditions include at least one condition including vacuum, pressure, and gas flow.

19. The substrate processing system of claim 15, wherein the substrate processing system is configured to remove the substrate from a heated substrate holder within the vacuum chamber before the vacuum chamber has reached predetermined environmental conditions.

20. The substrate processing system of claim 19, wherein the predetermined environmental conditions include at least one condition including vacuum, pressure, and gas flow.

21. A method of forming a film on a substrate, the method comprising:
depositing a sequence of liquid process chemicals on the substrate;
using one or more thermal processes to stabilize the film; and
using one or more vapor phase deposition processes to at least partially reduce exposure of the substrate to a corrosive environment by executing all processes within a sealed environment, the sealed environment being filled with at least one of a non-corrosive gas, a reducing gas, or a mixture of the non-corrosive gas and the reducing gas.
